(19) United States
(12) Patent Application Publication
(10) Pub. No.: US 2010/0259122 A1
(43) Pub. Date: Oct. 14, 2010

(54) Magnetic member, motor device, magnetizing method, and storage device

(76) Inventors: Isamu Takehara, Chiba-shi (JP); Shinji Kinoshita, Chiba-shi (JP); Hiromitsu Gotoh, Chiba-shi (JP)

Correspondence Address: BRUCE L. ADAMS, ESQ.;ADAMS & WILKS, SUITE 1231, 17 BATTERY PLACE, NEW YORK, NY, 10004, US

(21) Appl. No.: 12/660,738

(22) Filed: Mar. 3, 2010

Related U.S. Application Data
(62) Division of application No. 11/406,165, filed on Apr. 18, 2006.

(30) Foreign Application Priority Data
Apr. 20, 2005 (JP) 2005-122046

(51) Int. Cl. H02K 21/22; H02K 15/03

(52) U.S. Cl. 310/156.01; 29/598

(57) ABSTRACT

A method of magnetizing a magnetic member for a rotor of a motor device. The magnetic member has a thickness t in the radial direction of the magnetic member satisfying the relation πD/(0.75MP−π)<t≦πD/(0.5MP−π), where D represents an inner diameter of the magnetic member having a value of 20 mm or less, P represents the number of magnetic poles, and M represents the number of alternating current phases for driving the motor device. The magnetic member is magnetized unidirectionally in the radial direction of the magnetic member. Thereafter, the unidirectionally magnetized magnetic member is magnetized in partitions at regular intervals in the radial direction so that a magnetization direction of the magnetic member is reversed and the magnetic poles are arranged at regular intervals in a circumferential direction.

### BACKGROUND OF THE INVENTION

1. Field of the Invention

The present invention relates to a magnetic member, a motor device, a magnetizing method and a storage device, which are, for example, used for a small hard disk drive.

2. Description of the Related Art

In recent years, miniaturization of disc storage devices, such as hard disk drives and optical disk drives, are progressing rapidly, and devices with disc outer diameters of 1 inch or less are beginning to spread rapidly.

A small disc storage device is used for portable instruments, such as, for example, portable sound reproduction devices, digital cameras and cellular phones as well as for stationary devices, such as personal computers, office automation equipments and home information appliances.

Disc driving motors used in disc storage devices include an outer rotor type and an inner rotor type, but the outer rotor type suitable for miniaturization is mainly in use.

The outer rotor type motor arranges stator coils on the inner circumference of a cylindrical permanent magnet, and rotates the permanent magnet by the rotating magnetic field the stator coils generate.

On the other hand, the inner rotor type motor arranges stator coils on the outer circumference of a permanent magnet, and rotates the permanent magnet by the rotating magnetic field the stator coils generate.

Rare earth magnets are often used for the permanent magnet of the motor, and especially bonded magnets using an isotropic magnetic material, Nd—Fe—B, are frequently used.

These permanent magnets are manufactured by magnetizing the magnetic material formed in a cylindrical shape.

Magnetization is performed using a magnetizing head. In the case of the outer rotor type, a magnetizing head is inserted in the inner circumference of the magnetic material, and in the case of the inner rotor type, a magnetizing head is arranged on the outer circumference of the magnetic material.

A large current is instantaneously conducted through the magnetizing head to align the directions of the magnetic moments in the magnetic material by the magnetic field generated thereby.

In addition, the magnetization is done from the surface facing the stator coils, in order to make clear the partitions of N poles and S poles on the surface facing the stator coils.

However, since the magnetizing head has become miniaturized together with the miniaturization of the permanent magnet, conducting a large current is becoming difficult.

Thus, the magnetic material has not helped being magnetized to the magnetization level which is less than its intrinsic magnetic saturation capacity.

Therefore, the applicant of the present application disclosed the art for suitably magnetizing a small magnetic material in the following documents.

Patent document 1: Japanese Patent Application No. 2004-128101

Patent document 2: Japanese Patent Application No. 2004-147378

This art enables to magnetize the permanent magnet nearly to the magnetic saturation level even with a small electric current by making the wall thickness thin.

And the inventor clarified the limit of thickness possible to be made thin while keeping the motor highly efficient, in relation with the number of alternating current phases M used to drive the motor.

### SUMMARY OF THE INVENTION

Although a small permanent magnet has become possible to be magnetized excellently according to the arts disclosed in Patent documents 1 and 2, the problem of cogging has newly occurred with the development of thinner permanent magnets.

The cogging is related to the wall thickness of the permanent magnet, and the cogging is thought to become larger, as the thickness becomes smaller.

Thus, an object of the present invention is decreasing the cogging, while maintaining the magnetization of a small permanent magnet excellent.

In order to achieve the above object, the present invention provides a magnetic member which is disposed on a rotor of a motor device for driving said rotor, wherein, when the inner diameter of said magnetic member is denoted by D, the wall thickness thereof in the diameter direction by t, the number of magnetic poles magnetized in the radial direction by P, and the number of phases of an alternating current which drives said motor device by M, said D is set to 20 mm or less, and said t is set to satisfy the relation: πD/(0.75MP−π)<t≦πD/(0.5MP−π)(the 1st constitution).

In the 1st constitution, said magnetic member can also be made of an anisotropic Sm—Co based magnetic material of cylindrical shape with an outer diameter of 20 mm or less, wherein partitions with the aligned magnetization direction are formed at equal intervals in the circumferencial direction (The 2nd constitution).

The present invention also provides a motor device comprising: a rotor portion equipped with a rotationally symmetric body on which a cylindrical magnetic member is disposed covering the whole perimeter thereof, and with a rotary shaft disposed on the axis line of said rotationally symmetric body; a stator portion equipped with plural stator coils which can be magnetized by an alternating current with the phase number M, and are disposed on the inner or the outer circumference of said magnetic member facing said magnetic member; and a bearing part which supports pivotally said rotary shaft on said stator portion allowing a free rotation in a way that said rotationally symmetric body and said stator coils have the same axis, wherein said magnetic member is magnetized in the radial direction and the magnetic poles thereof are formed at equal intervals in the circumferencial direction; and when the inner diameter of the magnetic member is denoted by D, its wall thickness in the diameter direction by t, the number of said magnetic poles by P and the phase number of alternating current which drives said motor by M, said D is set to 20 mm or less, and said t is set to satisfy the relation: πD/(0.75MP−π)<t≦πD/(0.5MP−π) (The 3rd constitution).

The present invention also provides a magnetizing method for magnetizing a cylindrical magnetic member to be disposed on a rotor of a motor device so that the member is magnetized in the radial direction and the magnetic poles are formed at equal intervals in the circumferencial direction; wherein said magnetic member is constituted in a way that, when the inner diameter of said magnetic membrane is denoted by D, its wall thickness in the diameter direction by t, the number of the magnetic poles by P and the phase number of alternating current which drives said motor device by M, said D is 20 mm or less, and said t satisfies the relation: πD/(0.75MP−π)<t≦πD/(0.5MP−π); said magnetizing method comprising: a unidirectional magnetization step of magnetizing said magnetic member in one-direction, in the radial direction, and a polar magnetization step of magnetizing the magnetic member having been magnetized in said unidirectional magnetization step in one direction, in partitions at regular intervals in the radial direction to make the magnetization directions reversed (The 4th constitution).

The present invention also provides a storage device constituted using the motor device according to the 3rd constitution, comprising: a discoidal storage medium, a motor device according to the 3rd constitution for rotationally driving said storage medium, and an information reading means which reads information from said storage medium rotationally driven by said motor device (The 5th constitution).

According to the present invention, cogging of a small permanent magnet can be reduced while maintaining magnetization properties excellent.

### BRIEF DESCRIPTION OF THE DRAWINGS

FIG. 1 is an axial sectional view in axial direction of a motor.

FIG. 2 is a sectional view of the motor at the A-A line.

FIG. 3 is a diagram showing an outline and magnetic poles of a permanent magnet.

FIG. 4 is a table listing the combination of numbers of poles of the permanent magnet, numbers of slots, and numbers of phases of the alternating current.

FIG. 5 is a diagram for explaining the difference between isotropic and anisotropic magnetic materials.

FIG. 6 is an axial sectional view of a magnetic field orientation device.

FIG. 7 are diagrams showing a magnetizing head.

FIG. 8 is a graph estimating the reduction of residual magnetic flux densities by processing.

FIG. 9 is a graph estimating the reduction of energy products by processing.

FIG. 10 is a graph plotting the demagnetizing factor against temperature.

FIG. 11 are diagrams illustrating an internal configuration of a hard disk drive.

FIG. 12 is an axial sectional view of an inner rotor type motor.

### DESCRIPTION OF THE PREFERRED EMBODIMENTS

Hereafter, a suitable embodiment of the present invention is explained in detail.

### (1) An Outline of the Embodiment

When the inner diameter of the permanent magnetic membrane is D, the pitch per one magnetic pole is P and the phase number of the alternating current is M, an excellent permanent magnet with low cogging is obtained, by setting D to 20 mm or less, and setting the wall thickness of the permanent magnet t in the range described by the following relation (4).

πD/(0.75PM−π)<t≦πD/(0.5PM−π) (4)

In this embodiment, an outer rotor type permanent magnet is explained, but formula (4) is applicable also to an inner rotor type permanent magnet.

Moreover, in this embodiment, the formula can be desirably applied to a small permanent magnet with an outer diameter of 20 mm or less.

Furthermore, in this embodiment, a Sm—Co (samarium-cobalt) based magnetic material is adopted as a magnetic material.

Generally, as a wall thickness of the permanent magnet is made thinner, it will become easier to be demagnetized under the influence from outside, but when Sm—Co is used, demagnetization can be suppressed even if the wall thickness is thin, because a large amount of magnetic flux can be generated and a coercive force is large.

Furthermore, some Sm—Co based magnetic materials have anisotropy, and by magnetizing them after aligning magnetization axes of the whole magnetic materials with the magnetic field orientation, a larger amount of magnetic flux can be generated even if the wall thickness is thin.

### (2) Details of the Embodiment

Hereinafter, a suitable embodiment of the present invention is explained in detail.

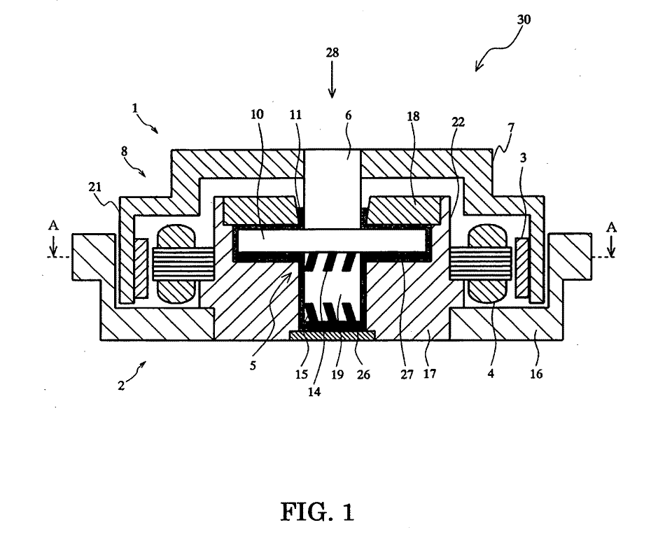

FIG. 1 is an axial sectional view illustrating an embodiment of a motor according to the present embodiment.

A motor 30 is an outer rotor type small motor, and is used, for example, for a hard disk drive, a magneto-optical disk drive and the like.

The motor 30 is a DC brushless motor driven by three phase alternating current, with an outer diameter of about 25 mm at the maximum, and thickness of about 5 mm at the maximum.

The motor 30 consists of a rotor portion 1 which performs rotational motion, and a stator portion 2 supporting this by a dynamic pressure bearing part 5.

The rotor portion 1 is equipped with a rotor 7 (a rotationally symmetric body) which is a convex disk member with a step part 8, and a rotary shaft (a shaft) 6 formed on the central axis of the rotor 7. By the way, the step part 8 is a part for mounting a storage disk in a hard disk drive.

On the outer circumference of the step part 8, a rotor frame 21 which is a cylindrical member is formed, and on the inner circumference surface of the rotor frame 21, a permanent magnet 3 formed in a cylindrical shape is bonded concentrically with the rotor frame 21.

The inner circumference surface of the permanent magnet faces to the stator coils 4 formed on the stator portion 2, being separated with a gap. The permanent magnet 3 constitutes a magnetic member for driving the rotor 7.

On the other hand, a discoidal dynamic pressure generation board 10 having a rotary shaft 6 as a central axis is formed near the central part in the direction of the axis of the rotary shaft 6. Although not shown in the figure, dynamic pressure generation grooves for generating dynamic pressure are formed on the front and the back surfaces of the dynamic pressure generation board 10, and the dynamic pressure in the thrust direction is generated at the time of rotation of the rotor 7.

Further, a dynamic pressure generation shaft 19 is formed on the central axis line of the dynamic pressure generation board 10 on the opposite side of the dynamic pressure generation board 10 from the rotary shaft 6.

On the peripheral surface of the dynamic pressure generation axis 19, dynamic pressure generation grooves consisting of two rows of slant grooves 14 and 15 which are inclined against the axis line in mutually different directions, are formed, and a dynamic pressure in the radial direction is generated at the time of the rotor 7 rotation.

The stator portion 2 consists of a stator frame 16, a base 17, an upper plate 18, stator coils 4, and the like.

The base 17 is a member for holding the rotor portion 1 by the dynamic pressure bearing part 5, and a housing hole 26 which receives the dynamic pressure generation shaft 19, and a housing hole 27 which receives the dynamic pressure generation board 10 are formed therein.

The upper plate 18, in which a through hole for loosely inserting the rotary shaft 6 is formed, is attached to an opening end of the housing hole 27.

A cavity is formed inside the base 17 by the upper plate 18 and the base 17, and the oil 11 for dynamic pressure generation is contained in this cavity together with the dynamic pressure generation board 10 and the dynamic pressure generation axis 19.

On the outer circumference of the base 17, plural stator coils 4 are disposed at equal intervals on a concentric circle. In addition, the outer circumference of the base 17 constitutes a sleeve 22.

A stator frame 16 is formed at the bottom of the base 17. Screw holes for fixing the motor 30 to a hard disk drive and the like are formed in the stator frame 16, which can fix the motor 30 by fixing the base 17 to a case.

The motor 30 constituted as described above operates as follows.

When a three phase alternating current is supplied to the stator coils 4, a rotating magnetic field will be generated at the inner circumference side of the permanent magnet 3.

The permanent magnet 3 is attracted by this rotating field, a torque is generated in the rotor portion 1, and the rotor 7 rotates.

As the rotor 7 rotates, dynamic pressure will be generated by the dynamic pressure bearing part 5, and the rotor portion 1 will be held by the dynamic pressure bearing part 5.

As described above, in the motor 30, the rotor portion 1 is held by the dynamic pressure bearing part 5, but it may not be limited to this, and may be supported, for example, by a ball bearing.

Moreover, when the motor 30 is constructed into an inner rotor type, the permanent magnet 3 is arranged on the outer circumference of the sleeve 22, and on the further outer circumference separated with a gap, the stator coils 4 are disposed. The constitution of an inner rotor type motor is described later.

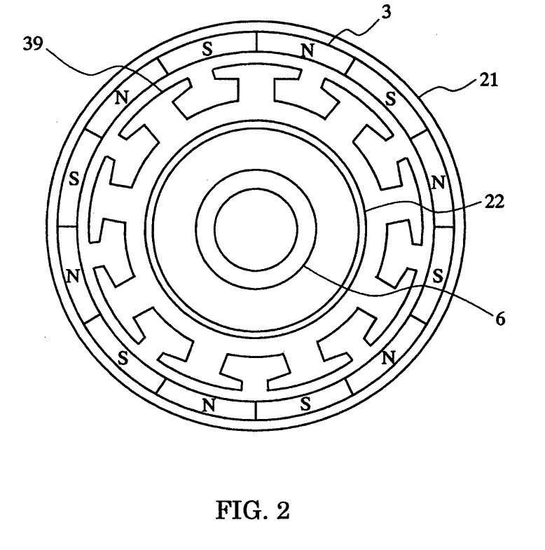

FIG. 2 is a diagram showing an outlined cross-section of the motor 30 at the A-A line (FIG. 1).

The motor 30 has twelve magnetic poles and nine slots, and is a DC brushless motor corresponding to the three phase alternating current.

On the periphery of the sleeve 22, nine stator cores projecting radially are formed at equal intervals. Although not illustrated, a winding wire for magnetization is coiled around each of the stator cores 39, and the stator coils 4 are formed in this way.

The permanent magnet 3 is equally divided into twelve by magnetic partitions in the circumferencial direction. Each partition is magnetized in the radial direction, i.e., from an inner circumference surface to the outer surface, or from the outer circumference surface to the inner surface. When magnetized from the inner circumferential surface to the outer circumferential surface, an N-pole is formed on the inner circumference surface and an S-pole is formed on the outer circumference surface. In this way, the permanent magnet 3 constitutes a twelve pole permanent magnet.

A character, N or S, given in the figure shows a magnetic pole appeared on the inner circumference surface of the permanent magnet 3 in each partition.

In this way, on the inner circumference surface of the permanent magnet 3, an N-pole and an S-pole are alternately formed along the circumferencial direction.

Next, the relation between the wall thickness t of the permanent magnet 3 and the phase number M of the alternating current is explained.

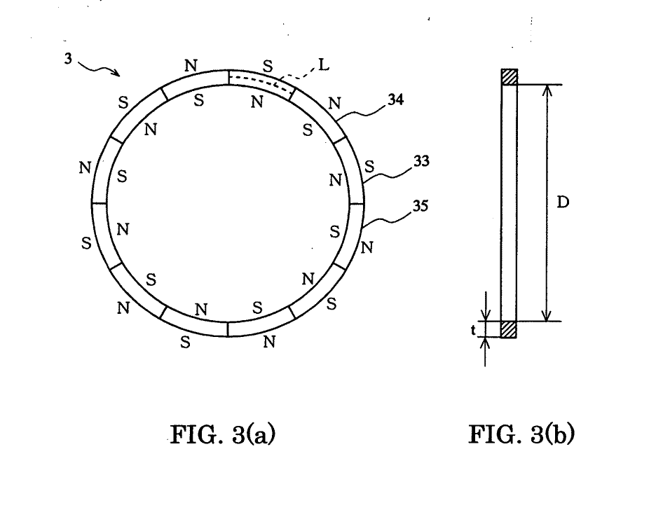

FIG. 3 is a diagram showing the contour and the magnetic poles of the permanent magnet 3. FIG. 3 (a) is the diagram of the permanent magnet 3 seen from the rotation axis direction (an arrow 28 in FIG. 1), and FIG. 3 (b) is a diagram of the permanent magnet 3 seen from the direction perpendicular to the arrow 28.

As shown in FIG. 3 (a), a pole pitch is denoted by L mm, and as shown in FIG. 3 (b), an inner diameter of the permanent magnet 3 by D mm (≦20 mm, preferably ≦10 ram), a wall thickness by t mm and the pole numbers of the permanent magnet 3 by P, and an outer diameter (D+2t) is set to 20 mm or less.

Here, when a circle is drawn in the middle of the radial direction between the inner and the outer circumferences of the permanent magnet 3, the pole pitch L is the length of a part of this circle contained in each partition.

First, the following formula (1) holds from the geometric shape of the permanent magnet 3.

PL=π+(D+t) (1)

The present inventors have found that when the ratio of a half of the wall thickness t to the pitch L is set to nearly the phase number of the alternating current, an excellent motor having little leakage of magnetic flux and little cogging was obtained. When the phase number of the alternating current is denoted by M, this experimental formula is expressed by the following formula (2).

L/t=0.5×M (2)

When L is eliminated from the above formulas (1) and (2), the following relation (3) between t and D is obtained.

t=πD/(0.5PM−π) (3)

Namely, when the phase number of the alternating current to drive the motor 30 is M, a specifically excellent motor with little cogging can be obtained by setting the wall thickness t of the permanent magnet 3 according to the formula (3). Moreover, with the thickness around this magnitude, the magnet can be magnetized to nearly the magnetic saturation.

Effect of the formula (3) to reduce the cogging is especially remarkable in the region where D is 10 mm or less.

Although the formula (2) is obtained from experiences by the experiments, the present inventors have guessed the rationale of a formula (2) as follows.

As disclosed in Patent documents 1 and 2, the present inventors have found out experientially that a good motor is obtained, when the relation, L/t=M, is fulfilled.

In the permanent magnet 3, each of the magnetic poles on the inner and the outer circumference sides is reversed with every partition, and each forms one magnetic pole.

Assuming that the magnetism is zero at the midpoint of the inner and the outer circumference of the permanent magnet 3, the permanent magnet 3 has a structure of double layers of the inner and the outer circumference sides.

Since a wall thickness of one layer is 0.5 t, the formula (2) is obtained by putting the wall thickness t to 0.5 t in the relation, L/t=M, found out in the previous documents.

By the way, if the permanent magnet is actually manufactured, variations may be arisen in the thickness around the wall thickness t of the formula (3). Taking into account that the architectural variation is generally allowed within about ±15% or less, the present inventors consider that the practical range of the wall thickness t is suitable to be the range of the formula (4) which makes the formula (3) as the maximum of the wall thickness t.

πD/(0.75PM−π)<t≦πD/(0.5PM−π) (4)

Here, the lower limit of the wall thickness t in the formula (4) was determined as follows.

When the magnetic flux leakage between the magnetic pole of the permanent magnet 3 and the stator core is taken into account, a limit of the thickness of a permanent magnet may be considered as the ratio of one pole pitch length occupied by the permanent magnet on the magnetic field side to one salient pole pitch occupied by the salient pole armature side. This pitch ratio is (πD/12 poles)/(πD/9 slots)=0.75. This is expressed by the following formula (5), and by introducing the formula (5) into formula (1), the lower limit of the formula (4) is obtained.

0.75M=L/t (5).

The cogging tends to become small as the wall thickness of the permanent magnet 3 becomes thick. The range of the wall thickness t expressed by the formula (4) is larger than the range of the wall thickness t shown in Patent documents. 1 and 2 (the formula (4) in Patent documents 1 and 2).

As an effect of the wall thickness t becoming thicker here, the cogging can be made smaller than that in the motor proposed in Patent documents 1 and 2.

As described above, the range of the wall thickness t which can realizes a small motor with excellent cogging characteristics can be specified from the relation with the phase number M.

Moreover, the permanent magnet with the wall thickness t of the range of the formula (4) can be magnetized to about the magnetic saturation by the magnetizing head.

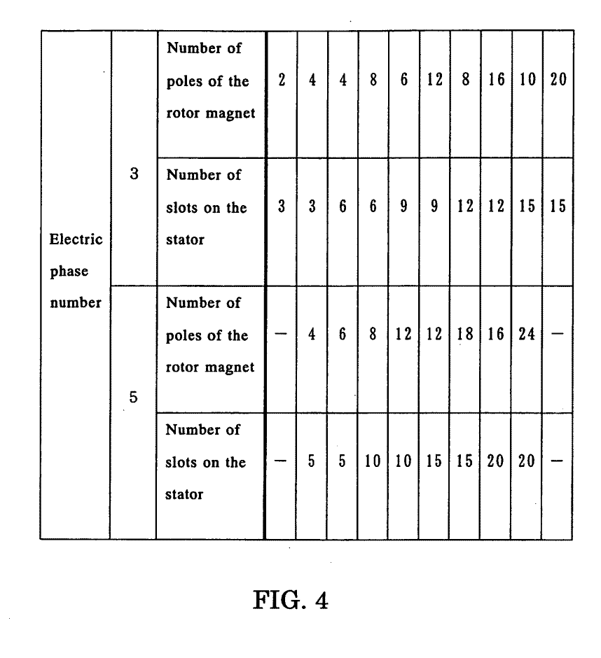

FIG. 4 is a table listing examples of the phase number of alternating current, the number of the poles of the permanent magnet, and the number of slots of the stator, available on the motor 30.

Although the motor most intensively used now is the one in which the phase number of alternating current is three, the permanent magnet has 12 poles and the slot number of the stator is 9, various kinds of combinations of the phase number, the pole number and the slot number are also possible, as are shown in this table.

For example, to an alternating current of 5 phases, the pole numbers of 4, 6, 8 . . . and the like are employable, and when the pole number is 4 or 6, the slot number is 5.

Next, magnetic materials are explained.

Although the magnetization property is improved by making wall thickness of the permanent magnet 3 thin in this embodiment, there is a problem that demagnetization easily occurs if wall thickness is made thin in the Nd—Fe—B based bond permanent magnet used conventionally.

In this embodiment, these problems were solved by using the Sm—Co based magnetic material.

It is known that the magnetic moment of the Sm—Co based permanent magnet is fixed by the pinning mechanism, and thus the Sm—Co based permanent magnet has smaller machining demagnetization and high temperature demagnetization compared with the Nd—Fe—B based permanent magnet having no pinning mechanism.

Although samarium (Sm) is an expensive material, the permanent magnet 3 can be manufactured with a low cost since the permanent magnet 3 has a small inner diameter and thin wall thickness, and only a little amount of samarium is necessary to be used.

In addition, in the Sm—Co based magnetic material, there are the anisotropic one and the isotropic one which is similar to the Nd—Fe—B based magnetic material, and the anisotropic material is superior to the isotropic one.

Here, the difference between the isotropic magnetic material and the anisotropic magnetic material is explained, using the manufacturing method of the permanent magnet.

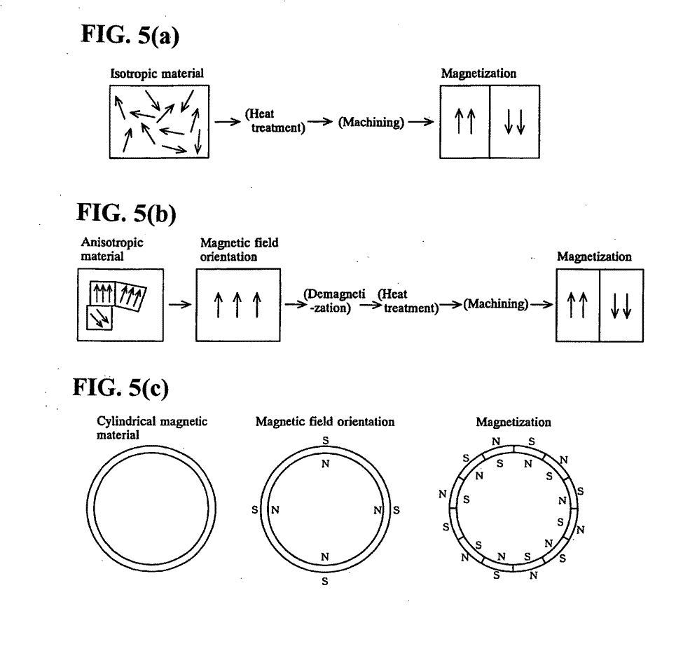

FIG. 5 (a) is a diagram for explaining the manufacturing method of the permanent magnet using an isotropic magnetic material.

As shown in the left end diagram, in the isotropic magnetic material, the directions of the magnetic moments are random in the stage of a raw material.

After the material is fabricated into a cylindrical shape, it is heat-treated, and then its outer size is adjusted by machining and is magnetized.

By the magnetization, the directions of the magnetic moments which have been at random, are arranged in the direction of the magnetic pole.

FIG. 5 (b) is a diagram for explaining the manufacturing method of the permanent magnet using an anisotropic magnetic material.

As shown in the left end diagram, the anisotropic magnetic material is constituted as an assembly of the regions (organizations) with aligned magnetic moments in the stage of raw material.

In the diagram, three regions having aligned magnetic moments are shown schematically and other areas are omitted.

After the material is fabricated into a cylindrical shape, magnetic field orientation is performed and then the magnetic material is magnetized in the radial direction.

Here, “magnetic field orientation” means a treatment to magnetize a material in one direction beforehand, to align the directions of the magnetic moments. It is known that a strong magnetic field can be obtained if a magnetization is conducted after performing magnetic field orientation.

Next, the magnetic pole formed by the magnetic field orientation is demagnetized. By demagnetization, the magnetic material can avoid to be tinged with magnetism while maintaining the magnetization direction of the magnetic material in the radial direction.

After that, like the isotropic magnetic material, after heat-treatment it is machined, and is magnetized.

FIG. 5 (c) is a diagram showing schematically the magnetic field orientation of the anisotropic magnetic material, and the magnetization direction by the magnetization.

As shown in the left end diagram, in the stage before the magnetic field orientation, it is not magnetized in any direction.

As shown in the central diagram, the magnetic material is magnetized to a monopole in the radial direction by a magnetic field orientation operation.

In the example of the diagram, the inner circumference side is magnetized to N-pole and the outer circumference side is magnetized to S-pole. It may be magnetized in the reverse direction.

Although not illustrated, when it is demagnetized, the direction of magnetization becomes random while maintaining the direction of each magnetic moment in a radial direction, and it has no magnetism as a whole.

As shown in the right end diagram, when it is magnetized, magnetic poles with a predetermined pole number are formed, and the permanent magnet 3 is obtained.

In the example of the right end diagram, the permanent magnet 3 is magnetized into 12 poles wherein the partition magnetized in a way that the inner circumference side has an S pole and the outer circumference side has an N pole, and the partition magnetized in the reversed direction are formed alternately at equal intervals.

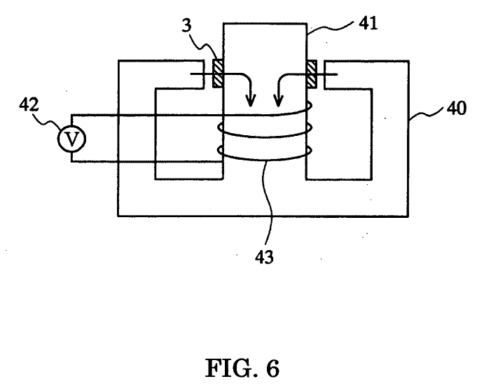

FIG. 6 is a figure showing schematically the sectional view in the axial direction of a magnetic field orientation device.

The magnetic field orientation device consists of a cylindrical iron core 41, a magnetic circuit 40, an electric power unit 42, and the like.

A winding wire 43 is given to the iron core 41, and a gap is formed around its upper part between the magnetic circuit 40.

When the permanent magnet 3 is loaded in this gap and a large pulse current is supplied from the power unit 42, the magnetic field orientation of the permanent magnet 3 is performed by the magnetic field generated in the gap.

Along with downsizing of the permanent magnet 3, the magnetic field orientation device is also miniaturized, and it becomes difficult to supply large current to the winding wire 43, but when the wall thickness t is in the range of the formula (4), it is possible to be magnetized to or near the magnetic saturation level.

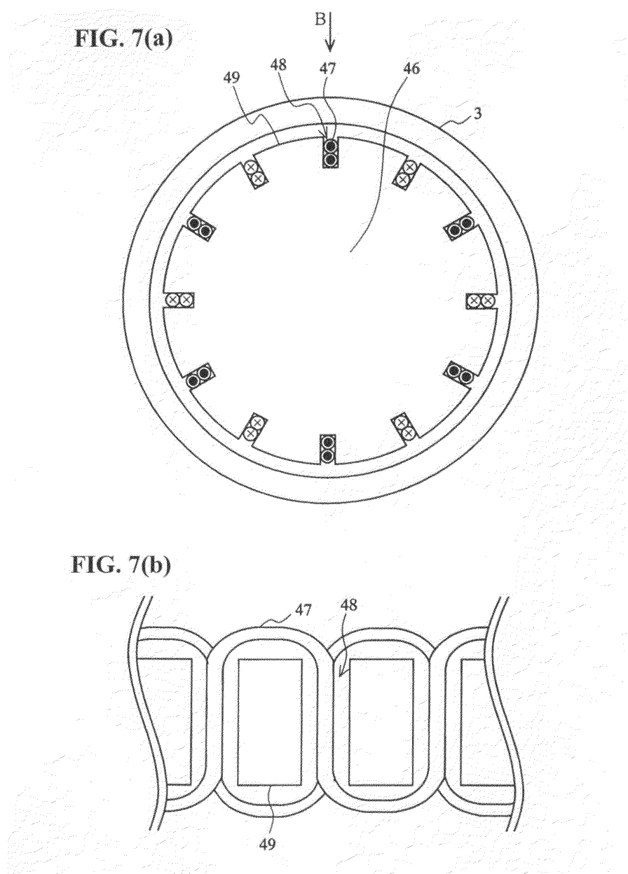

Next, a magnetizing head is explained using each diagram in FIG. 7.

Here, a magnetizing head for magnetizing a permanent magnet of an outer rotor type motor is explained as an example.

FIG. 7 (a) is a sectional view perpendicular to the magnetizing head axis.

The magnetizing head 46 is cylinder-shaped, and plural slots 48 are formed in the axis direction on the perimeter.

A lead wire 47 is looped around through each slot 48. The winding number is generally about once to about 4 times.

On the periphery of the magnetizing head 46, cores 49 separated by the slots 48 are formed corresponding to the magnetic poles of the permanent magnet 3.

FIG. 7 (b) is a diagram showing the magnetizing head 46 seen from the direction of the arrow B in FIG. 7 (a).

The lead wire 47 is disposed so that it zigzags through perimeters of the cores 49. Due to this, when a direct current is supplied to the lead wire 47, the magnetic poles magnetized on each of neighboring two cores 49 are opposite to each other.

When the permanent magnet 3 on which magnetic field orientation has been performed is placed around the magnetizing head 46 and a direct current is supplied to the lead wire 47, the permanent magnet 3 is magnetized by the magnetic field generated by the core 49.

Along with the miniaturization of the permanent magnet 3, the lead wire 47 becomes thinner, and it becomes difficult to apply large current, but when the wall thickness t is in the range of the formula (4), magnetization to or near the magnetic saturation is possible.

The magnetizing head 46 explained above magnetizes the permanent magnet for the outer rotor type motor. When magnetizing a permanent magnet of an inner rotor type motor, magnetization is performed arranging the cores on the outer circumference of the permanent magnet.

Namely, the permanent magnet is magnetized by making cores confront the face of the magnet which faces the stator coils in the motor device.

Next, physical properties of the magnetic material are explained.

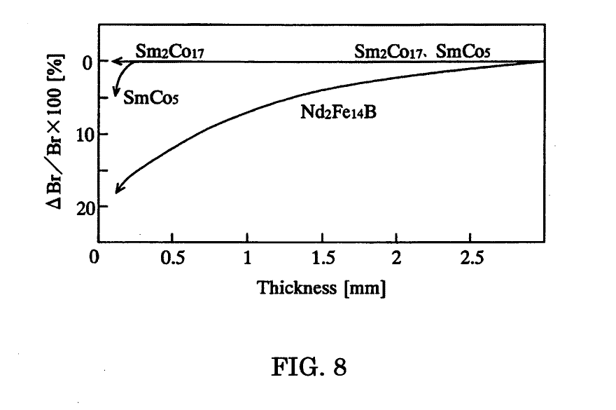

FIG. 8 is a graph showing the reduction of the residual magnetic flux density by machining the permanent magnet, estimated from various kinds of experiments.

For comparison, Nd₂Fe₁₄B which is an Nd—Fe—B based magnetic material, and Sm₂Co₁₇ and SmCo₅ which are Sm—Co based magnetic materials, were used.

By the way, Nd₂Fe₁₄B and SmCo₅ are isotropic magnetic materials, and Sm₂Co₁₇ is an anisotropic magnetic material.

The abscissa of this graph expresses the thickness of the permanent magnet in the radial direction, and the ordinate expresses the reduction rate of the residual magnetic flux density.

As shown in the figure, when thickness is about 2 mm or larger, there is no significant difference between the permanent magnet of Nd₂Fe₁₄B and those of Sm₂Co₁₇ and SmCo₅.

However, when the wall thickness becomes 2 mm or less, the residual magnetic flux density of the permanent magnet of Nd₂Fe₁₄B reduces rapidly, and at the thickness of about 1 mm, it reduces about 10%, while the residual magnetic flux density hardly reduces in the permanent magnets of Sm₂Co₁₇ and SmCo₅, even if the wall thickness becomes thin.

From these results, the Sm—Co based magnetic material is considered to be superior to the Nd—Fe—B based magnetic material in the region of 2 mm or less in thickness.

Further, in the region of the thickness of 0.5 mm or less it is presumed that the residual magnetic flux density of the permanent magnet of Sm₂Co₅ reduces about 20% but the residual magnetic flux density of the permanent magnet of Sm₂Co₁₇ does not reduce.

From this, it is considered that in the thickness region of 0.5 mm or less, the anisotropic Sm—Co based magnetic material is superior to the isotropic Sm—Co based magnetic material.

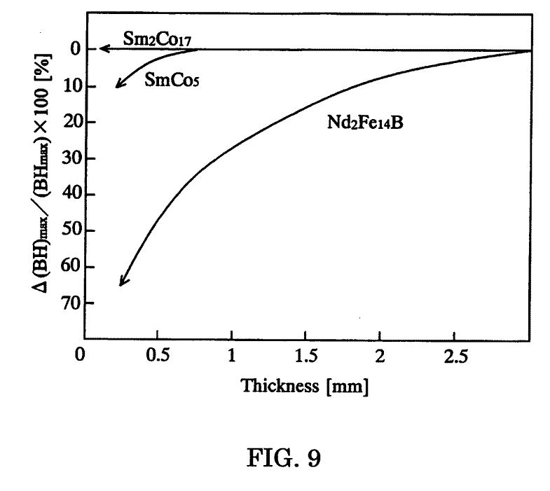

FIG. 9 is a graph showing the reduction of the maximum energy product by machining the permanent magnet, estimated from various kinds of experiments.

The abscissa of this graph expresses the thickness of the permanent magnet in the radial direction, and the ordinate indicates the energy product.

As shown in the figure, when thickness is about 2 mm or larger, there is no significant difference between the permanent magnet of Nd₂Fe₁₄B, and those of Sm₂Co₁₇ and SmCo₅.

However, when the wall thickness becomes 2 mm or less, the energy product of the permanent magnet of Nd₂Fe₁₄B reduces rapidly, and at the thickness of about 1 mm it reduces about 30%.

In contrast to this, the energy product hardly falls in the permanent magnets of Sm₂Co₁₇ and SmCo₅, even if the wall thickness becomes thin.

From these results, it is considered that in the thickness region of 2 mm or less, the Sm—Co based magnetic material is superior to the Nd—Fe—B based magnetic material.

Further, in the region of the thickness of 0.5 mm or less, it is presumed that the energy product of the permanent magnet of SmCo₅ reduces, but the energy product of the permanent magnet of Sm₂Co₁₇ does not reduce.

From this, it is considered that in the thickness region of 0.5 mm or less, the anisotropic Sm—Co based magnetic material is superior to the isotropic Sm—Co based magnetic material.

The permanent magnet for the motor may sometimes be processed by polishing and cutting after the magnetization. The results in FIGS. 8 and 9 indicate that in the region of the thickness in the radial direction of 2 mm or less, it is desirable to use the Sm—Co based permanent magnet, especially the anisotropic Sm—Co based permanent magnet, rather than the Nd—Fe—B based permanent magnet.

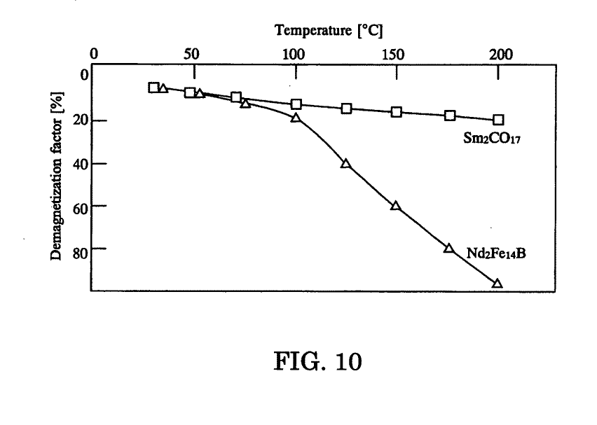

FIG. 10 is a graph showing the demagnetization factor of the permanent magnet by the temperature.

Up to about 100° C., the demagnetization factor of the permanent magnet of Nd₂Fe₁₄B and that of Sm₂Co₁₇ are both about several percent.

In the region at 100° C. or higher, the demagnetization factor of the permanent magnet of Nd₂Fe₁₄B becomes large rapidly and it reduces 80% or more near 200° C., while the demagnetization factor of the permanent magnet of Sm₂Co₁₇ is only about 20% even near 200° C.

From the above results, it is considered that the demagnetization by heat of the Sm—Co based magnetic material is smaller than that of the Nd—Fe—B based magnetic material.

From FIGS. 8 to 10 given above, it turns out that the permanent magnet 3 with large resistance against the machining and the heat demagnetization can be manufactured, by using the Sm—Co based permanent magnet, especially the anisotropic Sm—Co based permanent magnet.

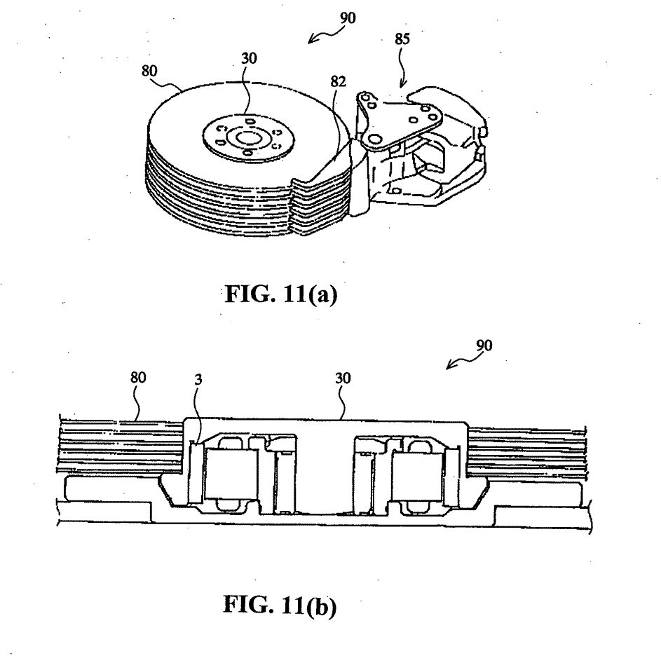

FIG. 11 are figures showing the internal configuration of the hard disk drive (the storage device) constituted making use of the motor 30.

Among these, FIG. 11 (a) shows the perspective view of the internal configuration 90, and FIG. 11 (b) shows an axial sectional view of the motor 30. Here, the arms 82 and the drive mechanism 85 are omitted in FIG. 11 (b).

The internal configuration 90 consists of the motor 30, storage disks 80, arms 82, a drive mechanism 85, and the like.

Although not illustrated, the internal configuration 90 is accommodated in a box-shaped case made of metals etc. And an electronic circuit for controlling the driving of the motor 30 or the drive mechanism 85, and for reading and writing the information from and on the storage disks 80 is installed in this case, and these constitute the hard disk drive.

The storage disk 80 is a discoidal metal plate with a mounting hole formed at the center, and whose front and back surfaces are made of magnetic materials for magnetic recording of information. The storage disks 80 constitute a discoidal storage medium.

The storage disks 80 consist of six sheets which are separated with each other by prescribed intervals and are fixed to the step part 8 (FIG. 1) of the motor 30 with the mounting holes.

The arm 82 is driven by the driving mechanism 85 to move in the radial direction of the storage disk 80, with a supporting point as a center of the movement, and can be located at the specified position of the storage disk 80.

The arm 82 has a magnetic head on its distal end, and reads or writes information from or on the storage disk 80 at the specified position of the storage disk 80. The arms 82 constitute information reading means.

There are 12 arms 82, and each of them corresponds to a front or a back side of a storage disk 80, respectively. Therefore, the internal configuration 90 can read and write information from and on the front and back sides of all the storage disks 80.

The driving mechanism 85 consists of permanent magnets, electromagnets, and the like, and makes the arm 82 rotationally move around the supporting point by the electromagnetic force.

The permanent magnet 3 explained above is used in the motor 30.

Although the aboves have been explained, adopting the case of the outer rotor type motor 30 as an example, the permanent magnet 3 can also be applied to the inner rotor type motor. Therefore, the structure of the inner rotor type motor is also explained.

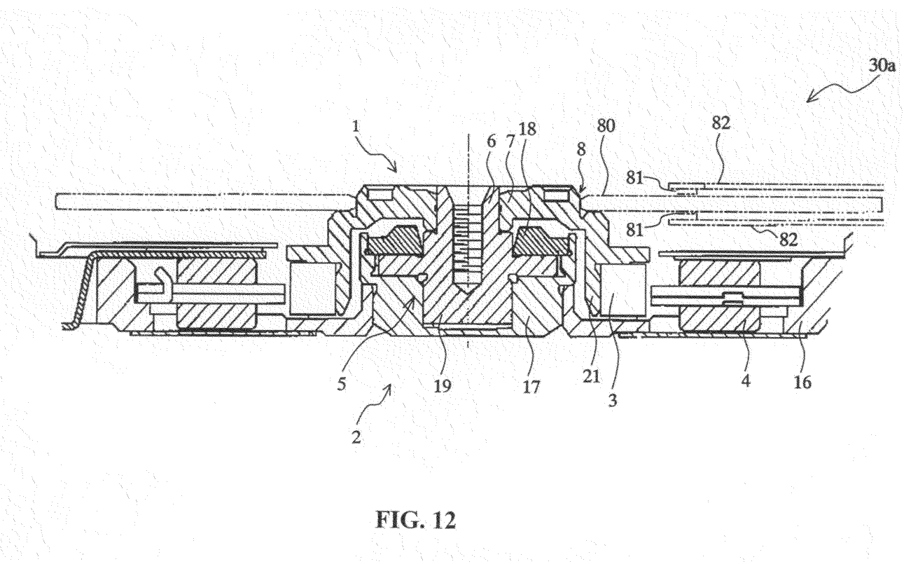

FIG. 12 is an axial sectional view of the inner rotor type motor.

A motor 30a constitutes an inner rotor type motor. The same number is given to the component corresponding to the component of the motor 30 (FIG. 1).

The motor 30a consists of a rotor portion 1 performing rotational motion, and a stator portion 2 supporting this by a dynamic pressure bearing part 5.

The rotor portion 1 is equipped with a rotor 7 which is a convex disk member having a step part 8 and a rotary shaft (shaft) 6 formed on the central axis of the rotor 7. Here, the step part 8 is a part for mounting storage disks 80 in a hard disk drive.

In the hard disk drive, arms 82 are disposed on the front and back sides of each storage disk 80, and data are read from and written on both sides of the storage disks 80 by a magnetic head 81 formed at the tip of the arm 82.

A rotor frame 21, a cylindrical member, is formed on the outer circumference of the step part 8, and the permanent magnet 3 formed in a cylindrical shape is bonded on the outer circumference of the rotor frame 21, concentrically with the rotor frame 21.

The outer circumference of the permanent magnet 3 faces to the stator coils 4 formed on the stator portion 2, being separated with a gap. The permanent magnet 3 constitutes a magnetic member for driving the rotor 7.

On the other hand, a discoidal dynamic pressure generation board 10 having a rotary shaft 6 as a central axis is formed near the central part in the direction of the axis of the rotary shaft 6. Although not shown in the figure, dynamic pressure generation grooves for generating dynamic pressure are formed on the front and the back sides of the dynamic pressure generation board 10, and the dynamic pressure in the thrust direction is generated at the time of the rotor 7 rotation.

Further, on the opposite side of the dynamic pressure generation board 10 from the rotation axis 6, a dynamic pressure generation shaft 19 is formed on the central axis line of the dynamic pressure generation board 10.

On the peripheral surface of the dynamic pressure generation shaft 19, in the same way as the motor 30, dynamic pressure generation grooves consisting of two rows of slant grooves which are inclined against the axis line in the mutually different direction, are formed, and a dynamic pressure in the radial direction is generated at the time of the rotor 7 rotation.

By the way, in FIG. 12, the rotary shaft 6, the dynamic pressure generation board 10, and the dynamic pressure generation shaft 19 are formed in a unit, which is set in a through hole formed in the center of the rotor 7.

The stator portion 2 consists of a stator frame 16, a base 17, an upper plate 18, stator coils 4, and the like.

The base 17 is a member for holding the rotor portion 1 by the dynamic pressure bearing part 5, and a cavity for housing the dynamic pressure generation board 10, the dynamic pressure generation shaft 19 and the oil for generating dynamic pressure, are formed.

And, the upper plate 18, in which a through hole for inserting the rotary shaft 6 loosely is formed, is attached at the top of the cavity.

A stator frame 16 is formed at the bottom of the base 17. The stator frame 16 is a disk member formed in a concave shape, with plural stator coils 4 disposed at equal intervals on its inner circumference. The permanent magnet 3 and the stator coils 4 face with each other, separated by a predetermined gap.

The motor 30a constituted as above operates as follows.

When a three phase alternate current is supplied to the stator coils 4, a rotating magnetic field is generated at the outer circumference side of the permanent magnet 3.

The permanent magnet 3 is attracted by this rotating field, a torque is generated in the rotor portion 1, and the rotor 7 rotates.

As the rotor 7 rotates, dynamic pressure is generated by the dynamic pressure bearing part 5, and the rotor portion 1 is supported by the dynamic pressure bearing part 5.

The following effects can be obtained by the present embodiment explained above.

(1) By setting the wall thickness t in the range indicated by the equation (4), the permanent magnet can be magnetized to or near the magnetic saturation, and also the cogging thereof can be reduced.
(2) By forming the permanent magnet using the Sm—Co based magnetic material, machining demagnetization, heat demagnetization, and the like are reduced and the quality is stabilized.
(3) Especially by using an anisotropic Sm—Co based magnetic material, the quality is still more stabilized.
(4) The cogging and the pure tone are improved by making the permanent magnet multipole.

1.-5. (canceled)

6. A method of magnetizing a magnetic member for a rotor of a motor device, the method comprising:
providing a magnetic member having a thickness t in the radial direction of the magnetic member satisfying the relation πD/(0.75MP−π)<t≦πD/(0.5MP−π), where D represents an inner diameter of the magnetic member having a value of 20 mm or less, P represents the number of magnetic poles, and M represents the number of alternating current phases for driving the motor device;
magnetizing the magnetic member unidirectionally in the radial direction of the magnetic member; and
magnetizing the unidirectionally magnetized magnetic member in partitions at regular intervals in the radial direction so that a magnetization direction of the magnetic member is reversed and the magnetic poles are arranged at regular intervals in a circumferential direction.

7. A method according to claim 6; wherein the magnetic member is cylindrical-shaped.

8. A method according to claim 6; wherein the magnetic member is cylindrical-shaped with an outer diameter of 20 mm or less and is formed of an anisotropic Sm—Co based magnetic material.

9. A method according to claim 6; wherein the number of magnetic poles of the magnetic member is selected from 4, 6, 8, 10, 12, 16, 18 and 20.

10. A method according to claim 6; wherein the number of magnetic poles of the magnetic member is selected from 4, 6, 8, 10, 12, 16 and 20 when M=3; and wherein the number of magnetic poles of the magnetic member is selected from 4, 6, 8, 12, 16 and 18 when M=5.

11. A method according to claim 6; wherein the number of magnetic poles of the magnetic member is selected from 4, 6, 8, 10, 12, 16, 18 and 20.

12. A method according to claim 6; wherein the number of magnetic poles of the magnetic member is selected from 4, 6, 8, 10, 12, 16 and 20 when M=3; and wherein the number of magnetic poles of the magnetic member is selected from 4, 6, 8, 12, 16 and 18 when M=5.

13. A method of magnetizing a permanent magnet for a rotor of an inner rotor-type motor device, the method comprising:
providing a permanent magnet for a rotor of an inner rotor-type motor device, the permanent magnet having a thickness t in the radial direction of the permanent magnet satisfying the relation πD/(0.75MP−π)<t≦πD/(0.5MP−π), where D represents an inner diameter of the permanent magnet having a value of 20 mm or less, P represents the number of magnetic poles, and M represents the number of alternating current phases for driving the inner rotor-type motor device;
magnetizing the permanent magnet unidirectionally in the radial direction of the permanent magnet; and
magnetizing the unidirectionally magnetized permanent magnet in partitions at regular intervals in the radial direction so that a magnetization direction of the permanent magnet is reversed and the magnetic poles are arranged at regular intervals in a circumferential direction.

14. A method according to claim 13; wherein the permanent magnet is cylindrical-shaped.

15. A method according to claim 13; wherein the permanent magnet is cylindrical-shaped with an outer diameter of 20 mm or less and is formed of an anisotropic Sm—Co based magnetic material.

16. A method of magnetizing a permanent magnet for a rotor of an outer rotor-type motor device, the method comprising:
providing a permanent magnet for a rotor of an outer rotor-type motor device, the permanent magnet having a thickness t in the radial direction of the permanent magnet satisfying the relation πD/(0.75MP−π)<t≦πD/(0.5MP−π), where D represents an inner diameter of the permanent magnet having a value of 20 mm or less, P represents the number of magnetic poles, and M represents the number of alternating current phases for driving the outer rotor-type motor device;
magnetizing the permanent magnet unidirectionally in the radial direction of the permanent magnet; and
magnetizing the unidirectionally magnetized permanent magnet in partitions at regular intervals in the radial direction so that a magnetization direction of the permanent magnet is reversed and the magnetic poles are arranged at regular intervals in a circumferential direction.

17. A method according to claim 16; wherein the permanent magnet is cylindrical-shaped.

18. A method according to claim 16; wherein the permanent magnet is cylindrical-shaped with an outer diameter of 20 mm or less and is formed of an anisotropic Sm—Co based magnetic material.
